(19) United States
(12) Patent Application Publication
(10) Pub. No.: US 2025/0220344 A1
(43) Pub. Date: Jul. 3, 2025

(54) ELECTRONIC DEVICE FOR PROCESSING AUDIO, AND OPERATION METHOD OF ELECTRONIC DEVICE

(71) Applicant: Samsung Electronics Co., Ltd., Suwon-si (KR)

(72) Inventors: Jaemo YANG, Suwon-si (KR); Seonmi KIM, Suwon-si (KR); Hangil MOON, Suwon-si (KR); Kyoungho BANG, Suwon-si (KR); Sanghoon LEE, Suwon-si (KR); Hochul HWANG, Suwon-si (KR)

(21) Appl. No.: 19/082,832

(22) Filed: Mar. 18, 2025

Related U.S. Application Data
(63) Continuation of application No. PCT/KR2023/015095, filed on Sep. 27, 2023.

(30) Foreign Application Priority Data
Sep. 27, 2022 (KR) 10-2022-0122710
Nov. 8, 2022 (KR) 10-2022-0148103

(51) Int. Cl. H04R 3/00; H04R 5/027; H04R 5/033; H04S 3/00; H04S 7/00

(52) U.S. Cl. CPC H04R 3/005; H04R 5/027; H04R 5/033; H04S 3/008; H04S 7/304; H04R 2201/401; H04S 2400/01; H04S 2400/11; H04S 2400/13; H04S 2400/15

(57) ABSTRACT

An electronic device is provided. The electronic device includes a first microphone disposed on the left front surface of the electronic device to collect sound of a first input channel, a second microphone disposed on the left rear surface of the electronic device to collect sound of a second input channel, a third microphone disposed on the right front surface of the electronic device to collect sound of a third input channel, a fourth microphone disposed on the right rear surface of the electronic device to collect sound of a fourth input channel, memory storing one or more computer programs, and one or more processors communicatively coupled to the first microphone, the second microphone, the third microphone, the fourth microphone, and the memory, wherein the one or more computer programs include computer-executable instructions that, when executed by the one or more processors individually or collectively, cause the electronic device to preprocesses the sound of the first input channel, the sound of the second input channel, the sound of the third input channel, and the sound of the fourth input channel, and operate in a first mode that records immersive audio based on the preprocessed sound of the first input channel, the preprocessed sound of the second input channel, the preprocessed sound of the third input channel, and the preprocessed sound of the fourth input channel or operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

### CROSS-REFERENCE TO RELATED APPLICATION(S)

This application is a continuation application, claiming priority under 35 U.S.C. § 365 (c), of an International application No. PCT/KR2023/015095, filed on Sep. 27, 2023, which is based on and claims the benefit of a Korean patent application number 10-2022-0122710, filed on Sep. 27, 2022, in the Korean Intellectual Property Office, and of a Korean patent application number 10-2022-0148103, filed on Nov. 8, 2022, in the Korean Intellectual Property Office, the disclosure of each of which is incorporated by reference herein in its entirety.

### BACKGROUND

### 1. Field

The disclosure relates to an electronic device for processing audio and a method of operating the same.

### 2. Description of Related Art

Augmented reality (AR) glasses are a next generation personal device, and various functions that may be applied to AR glasses are being developed.

Augmented reality glasses, which are head-mounted displays (HMD) devices having a similar form to that of glasses, may be worn by a user as if the user is wearing glasses, with both temples positioned on the user's ears and a nose pad positioned on the top of the user's nose.

An electronic device includes a multi-microphone array may perform positional processing of target sound sources, sound source separation, beamforming, and/or immersive three-dimensional (3D) audio processing using a plurality of microphones.

The above information is presented as background information only to assist with an understanding of the disclosure. No determination has been made, and no assertion is made, as to whether any of the above might be applicable as prior art with regard to the disclosure.

### SUMMARY

In the case of AR glasses including a single channel microphone, there is a limitation that the AR glasses are susceptible to noise when receiving a user's voice, and a voice recognition rate may be low. Further, in the case of recording ambient audio with a single channel microphone, immersive 3D audio processing may be difficult.

An embodiment disclosed in this document may include a plurality of microphones in AR glasses to provide various types of sound collection functions.

For example, the electronic device of the disclosure may perform various forms of audio signal processing using multiple microphones according to various constitutions and dispositions.

For example, the electronic device of the disclosure may further utilize a vibration sensor to detect vibrations when a user speaks and perform various forms of audio signal processing.

Technical problems to be achieved in this document are not limited to the above-described technical problems, other technical problems not described will be clearly understood by those skilled in the art to which the disclosure belongs from the description below.

Aspects of the disclosure are to address at least the above-mentioned problems and/or disadvantages and to provide at least the advantages described below. Accordingly, an aspect of the disclosure is to provide an electronic device for processing audio and a method of operating the same.

Additional aspects will be set forth in part in the description which follows and, in part, will be apparent from the description, or may be learned by practice of the presented embodiments.

In accordance with an aspect of the disclosure, an electronic device is provided. The electronic device includes a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, a fourth microphone disposed at a right rear surface thereof to collect a sound of a fourth input channel, memory storing one or more computer programs, and one or more processors communicatively coupled to the first microphone, the second microphone, the third microphone, the fourth microphone, and the memory, wherein the one or more computer programs include computer-executable instructions that, when executed by the one or more processors individually or collectively, cause the electronic device to preprocess the sound of the first input channel, the sound of the second input channel, the sound of the third input channel, and the sound of the fourth input channel, and operate in a first mode that records immersive audio based on the preprocessed sound of the first input channel, the preprocessed sound of the second input channel, the preprocessed sound of the third input channel, and the preprocessed sound of the fourth input channel, or operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

In accordance with another aspect of the disclosure, a method performed by an electronic device is provided. Wherein the electronic device includes a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, and a fourth microphone disposed at a right rear surface thereof to collect a sound of a fourth input channel, and the electronic device the sound of the first input channel, the sound of the second input channel, the sound of the third input channel, and the sound of the fourth input channel, and to operate in a first mode that records immersive audio based on the preprocessed sound of the first input channel, the preprocessed sound of the second input channel, the preprocessed sound of the third input channel, and the preprocessed sound of the fourth input channel, or to operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

For example, the electronic device may provide an immersive recording function using a plurality of microphones.

For example, the electronic device may track a position of a target sound using a plurality of microphones.

For example, the electronic device may form a low frequency beam using a plurality of microphones.

For example, the electronic device may collect and amplify a sound of a specific direction using a plurality of microphones.

For example, the electronic device may collect a sound with reduced noise other than a target sound using a plurality of microphones.

For example, the electronic device may detect a user's voice when the user speaks using sensors and a plurality of microphones.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. Wherein the electronic device includes a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, and a fourth microphone disposed at a right rear surface thereof to collect a sound of a fourth input channel, and wherein the operations include preprocessing, by the electronic device, the sound of the first input channel, the sound of the second input channel, the sound of the third input channel, and the sound of the fourth input channel, and operating, by the electronic device, in a first mode that records immersive audio based on the preprocessed sound of the first input channel, the preprocessed sound of the second input channel, the preprocessed sound of the third input channel, and the preprocessed sound of the fourth input channel, or operating, by the electronic device, in a second mode that receives a sound of a designated direction using beamforming based on the preprocessed sound of the first input channel, the preprocessed sound of the second input channel, the preprocessed sound of the third input channel, and the preprocessed sound of the fourth input channel.

Other aspects, advantages, and salient features of the disclosure will become apparent to those of skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to an embodiment of the disclosure;

FIG. 2 is a block diagram illustrating an audio module according to an embodiment of the disclosure;

FIG. 3A is a diagram illustrating an overall constitution of an electronic device according to an embodiment of the disclosure;

FIG. 3B is a block diagram illustrating an electronic device according to an embodiment of the disclosure;

FIGS. 3C, 3D, and 3E are diagrams illustrating different dispositions of a plurality of microphones and sensors in an electronic device according to various embodiments of the disclosure;

FIG. 4 is a flowchart illustrating a method in which a processor operates in a reception mode according to an embodiment of the disclosure;

FIGS. 5A, 5B, 5C, and 5D are block diagrams illustrating a processor operating in a first mode according to various embodiments of the disclosure;

FIGS. 6A and 6B are block diagrams illustrating a processor operating in a second mode according to various embodiments of the disclosure;

FIG. 7 is a block diagram illustrating a processor operating in a third mode according to an embodiment of the disclosure; and

FIGS. 8A, 8B and 8C are diagrams illustrating an example of disposing at least one microphone in an electronic device according to an embodiment of the disclosure.

Throughout the drawings, like reference numbers will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular form “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

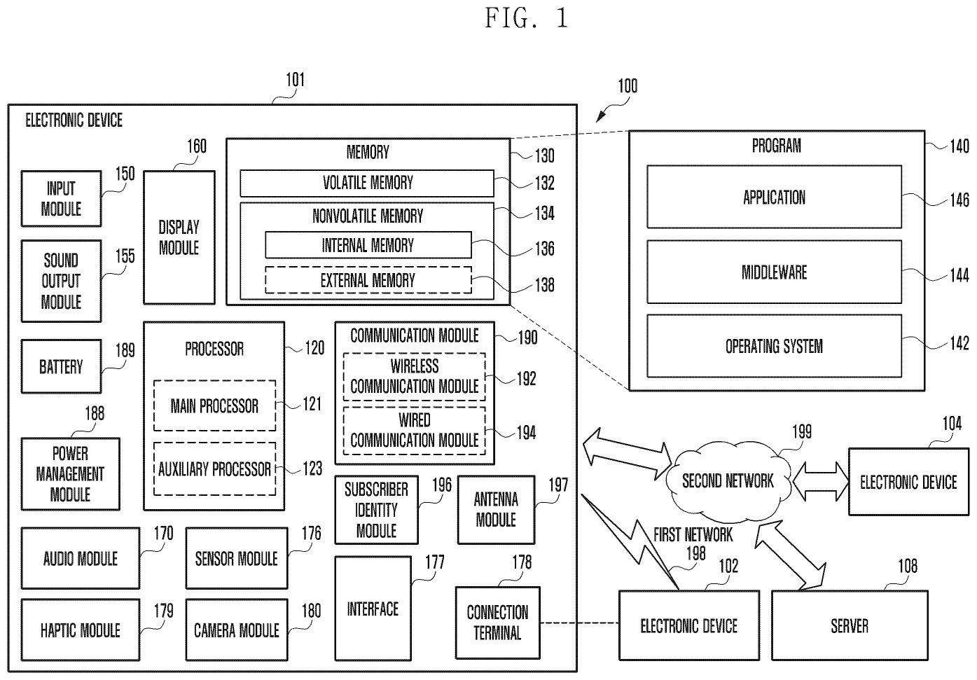

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

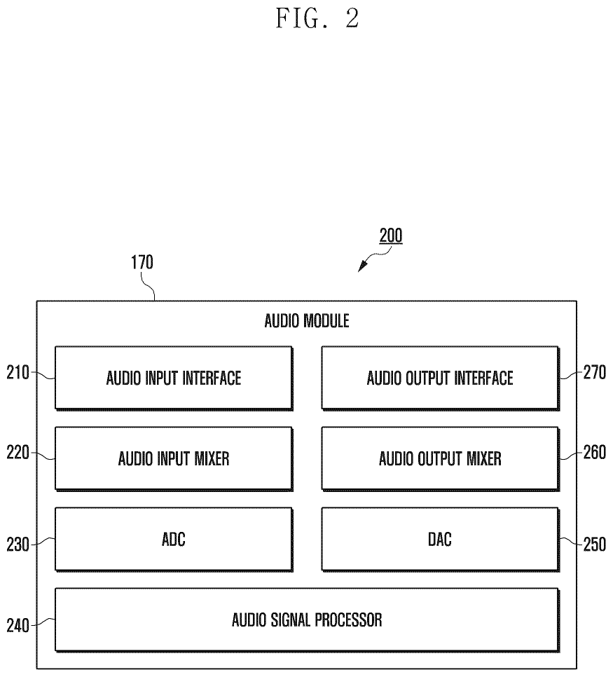

FIG. 2 is a block diagram illustrating an audio module according to an embodiment of the disclosure.

Referring to FIG. 2, in a block diagram 200 the audio module 170 may include, for example, an audio input interface 210, an audio input mixer 220, an analog to digital converter (ADC) 230, an audio signal processor 240, a digital to analog converter (DAC) 250, an audio output mixer 260, or an audio output interface 270.

The audio input interface 210 may receive an audio signal corresponding to a sound acquired from the outside of the electronic device 101 as part of the input module 150 or through a microphone (e.g., dynamic microphone, condenser microphone, or piezo microphone) constituted separately from the electronic device 101. For example, in the case that an audio signal is acquired from an external electronic device 102 (e.g., headset or microphone), the audio input interface 210 may be directly connected to the external electronic device 102 through the connection terminal 178 or wirelessly (e.g., Bluetooth communication) through the wireless communication module 192 to receive an audio signal. According to an embodiment, the audio input interface 210 may receive a control signal (e.g., volume adjustment signal received through an input button) related to the audio signal acquired from the external electronic device 102. The audio input interface 210 may include a plurality of audio input channels and receive different audio signals for each corresponding audio input channel among the plurality of audio input channels. According to an embodiment, additionally or alternatively, the audio input interface 210 may receive audio signals from another component (e.g., the processor 120 or the memory 130) of the electronic device 101.

The audio input mixer 220 may synthesize a plurality of input audio signals into at least one audio signal. According to an embodiment, the audio input mixer 220 may synthesize a plurality of analog audio signals input through the audio input interface 210 into at least one analog audio signal.

The ADC 230 may convert an analog audio signal into a digital audio signal. For example, according to an embodiment, the ADC 230 may convert an analog audio signal received through the audio input interface 210, or additionally or alternatively, an analog audio signal synthesized through an audio input mixer 220, into a digital audio signal.

The audio signal processor 240 may perform various processing on a digital audio signal input through the ADC 230 or a digital audio signal received from another component of the electronic device 101. For example, according to an embodiment, the audio signal processor 240 may change a sampling rate, apply one or more filters, perform interpolation processing, amplify or attenuate all or part of a frequency band, perform noise processing (e.g., noise or echo attenuation), change a channel (e.g., switching between mono and stereo), perform mixing, or extract a designated signal on one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal acquired from another component (e.g., the processor 120 or the memory 130) of the electronic device 101 into an analog audio signal.

The audio output mixer 260 may synthesize a plurality of audio signals to be output into at least one audio signal. According to an embodiment, the audio output mixer 260 may synthesize an audio signal converted into analog through the DAC 250 and another analog audio signal (e.g., analog audio signal received through the audio input interface 210) into at least one analog audio signal.

The audio output interface 270 may output an analog audio signal converted through the DAC 250, or additionally or alternatively, an analog audio signal synthesized by the audio output mixer 260, to the outside of the electronic device 101 through the sound output module 155. The sound output module 155 may include, for example, a speaker such as a dynamic driver or a balanced armature driver, or a receiver. According to an embodiment, the sound output module 155 may include a plurality of speakers. In this case, the audio output interface 270 may output an audio signal having a plurality of different channels (e.g., stereo or 5.1 channel) through at least some speakers among the plurality of speakers. According to an embodiment, the audio output interface 270 may be directly connected to the external electronic device 102 (e.g., external speaker or headset) through the connection terminal 178 or wirelessly through the wireless communication module 192 to output an audio signal.

According to an embodiment, the audio module 170 may synthesize a plurality of digital audio signals using at least one function of the audio signal processor 240 without separately providing the audio input mixer 220 or the audio output mixer 260 to generate at least one digital audio signal.

According to an embodiment, the audio module 170 may include an audio amplifier (not illustrated) (e.g., speaker amplifier circuit) capable of amplifying an analog audio signal input through the audio input interface 210 or an audio signal to be output through the audio output interface 270. According to an embodiment, the audio amplifier may be implemented into a separate module from the audio module 170.

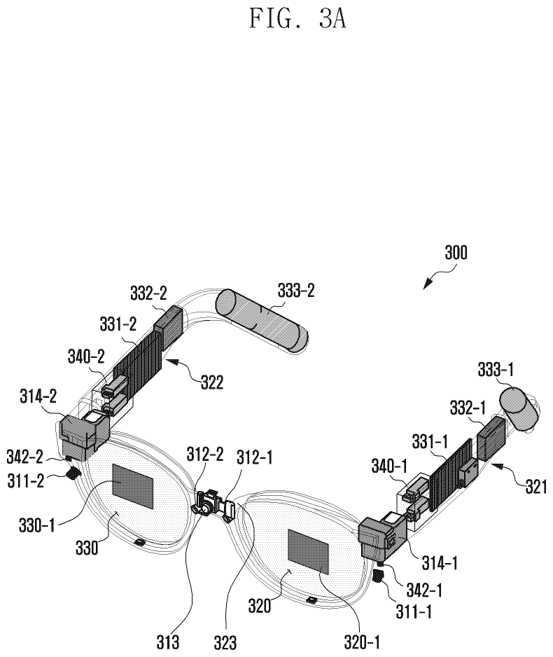

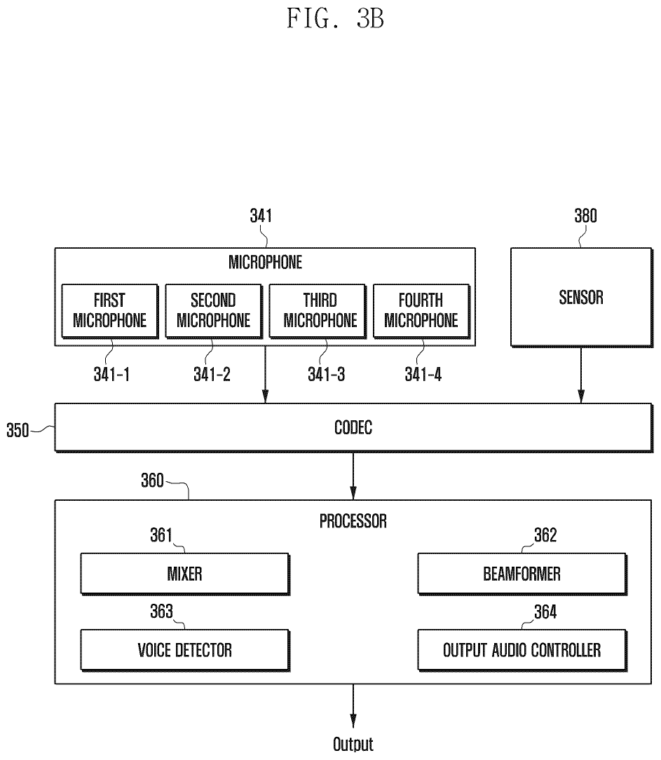

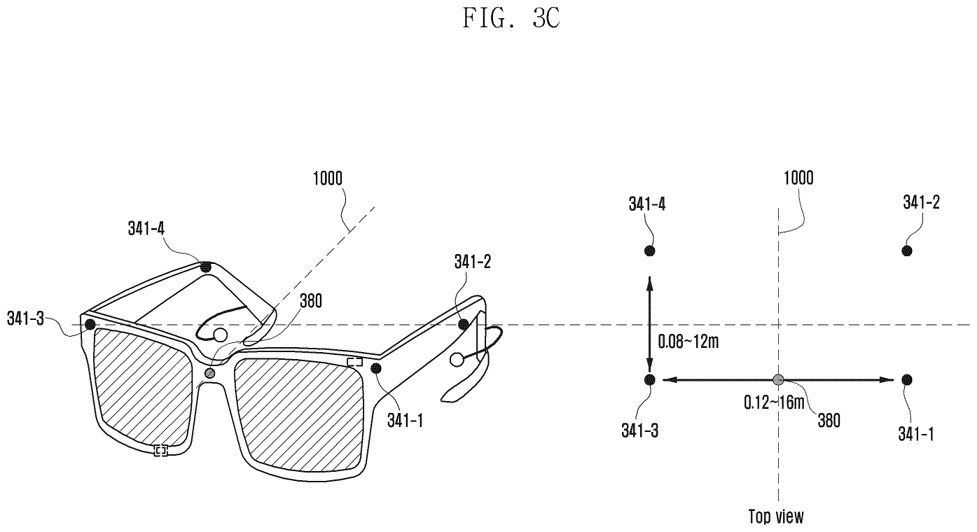

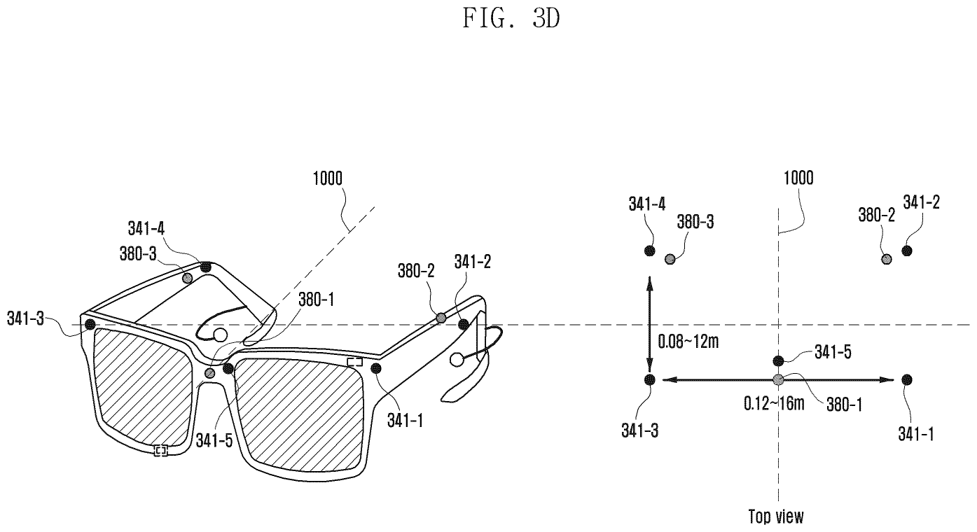

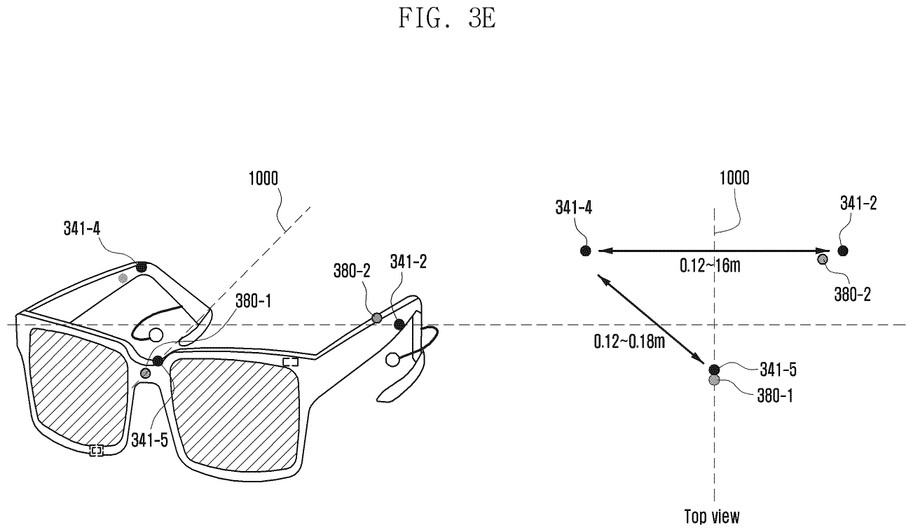

FIG. 3A is a diagram illustrating an overall constitution of an electronic device 300 according to an embodiment of the disclosure.

According to an embodiment, the electronic device 300 may be an electronic device 300 produced in a form to be worn on a user's head. For example, the electronic device 300 may be implemented in the form of at least one of glasses, goggles, a helmet, or a hat, but the disclosure is not limited thereto. According to an embodiment, the electronic device 300 may include a plurality of transparent members (e.g., a first transparent member 320 and/or a second transparent member 330) corresponding to each of the user's two eyes (e.g., a left eye and/or a right eye).

The electronic device 300 may provide an image related to an augmented reality (AR) service to a user. According to an embodiment, the electronic device 300 may project or display a virtual object on the first transparent member 320 and/or the second transparent member 330, thereby enabling at least one virtual object to be overlapped on the reality recognized by the user through the first transparent member 320 and/or the second transparent member 330 thereof.

Referring to FIG. 3A, the electronic device 300 according to an embodiment may include a main body 323, a support part (e.g., a first support part 321, a second support part 322), and a hinge part (e.g., a first hinge part 340-1, a second hinge part 340-2).

According to an embodiment, the main body 323 and the support parts 321 and 322 may be operatively connected through the hinge parts 340-1 and 340-2. The main body 323 may include a portion formed to be at least partially worn on a user's nose.

According to an embodiment, the support parts 321 and 322 may include a support member of a form that may be worn on the user's ear. The support parts 321 and 322 may include a first support part 321 worn on the user's left ear and/or a second support part 322 worn on the user's right ear.

According to an embodiment, the first hinge part 340-1 may connect the first support part 321 and the main body 323 so that the first support part 321 may be rotatable relative to the main body 323. The second hinge part 340-2 may connect the second support part 322 and the main body 323 so that the second support part 322 may be rotatable relative to the main body 323. According to another embodiment, the hinge parts 340-1 and 340-2 of the electronic device 300 may be omitted. For example, the main body 323 and the support parts 321 and 322 may be directly connected.

According to an embodiment, the main body 323 may include at least one transparent member (e.g., the first transparent member 320, the second transparent member 330), at least one display module (e.g., a first display module 314-1, a second display module 314-2), at least one camera module (e.g., a front photographing camera module 313, an eye tracking camera module (e.g., a first eye tracking camera module 312-1, a second eye tracking camera module 312-2), a gesture camera module (e.g., a first gesture camera module 311-1, a second gesture camera module 311-2), and at least one microphone (not illustrated).

In the case of the electronic device 300 described with reference to FIG. 3A, light generated in the display modules 314-1 and 314-2 may be projected onto the transparent member 320 and 330 to display information. For example, light generated in the first display module 314-1 may be projected onto the first transparent member 320, and light generated in the second display module 314-2 may be projected onto the second transparent member 330. Because light capable of displaying a virtual object is projected onto the transparent members 320 and 330 whose at least a portion is made of a transparent material, the user may recognize a reality in which the virtual object is overlapped. In this case, it may be understood that the display module 160 described with reference to FIG. 1 includes the display modules 314-1 and 314-2 and the transparent members 320 and 330 in the electronic device 300 illustrated in FIG. 3A.

However, the electronic device 300 described in the disclosure is not limited to displaying information in the manner described above. The display module that may be included in the electronic device 300 may be changed to a display module including various information display methods. For example, in the case that a display panel including a light emitting element made of a transparent material is built into the transparent members 320 and 330 itself, information may be displayed without a separate display module (e.g., the first display module 314-1, the second display module 314-2). In this case, the display module 160 described with reference to FIG. 1 may mean the transparent members 320 and 330 and the display panel included in the transparent members 320 and 330.

According to an embodiment, a virtual object output through the display modules 314-1 and 314-2 may include information related to an application program running on the electronic device 300 and/or information related to an external object positioned in a real space recognized by the user through the transparent members 320 and 330. The external object may include an object existing in the real space. The real space recognized by the user through the transparent members 320 and 330 will be referred to as a field of view (FoV) area of the user hereinafter. For example, the electronic device 300 may identify an external object included in at least a part of an area determined as the FoV of the user from image information related to a real space acquired through the camera module (e.g., the photographing camera module 313) thereof. The electronic device 300 may output a virtual object related to the identified external object through the display modules 314-1 and 314-2.

According to an embodiment, the electronic device 300 may display a virtual object related to an augmented reality service based on image information related to a real space acquired through the photographing camera module 313 thereof. According to an embodiment, the electronic device 300 may display a virtual object based on display modules disposed to correspond to both eyes of the user (e.g., the first display module 314-1 corresponding to the left eye and/or the second display module 314-2 corresponding to the right eye). According to an embodiment, the electronic device 300 may display a virtual object based on preconfigured configuration information (e.g., resolution, frame rate, brightness, and/or display area).

According to an embodiment, the transparent members 320 and 330 may include a light collecting lens (not illustrated) and/or a waveguide (e.g., a first waveguide 320-1 and/or a second waveguide 330-1). For example, the first waveguide 320-1 may be partially positioned in the first transparent member 320, and the second waveguide 330-1 may be partially positioned in the second transparent member 330. Light emitted from the display modules 314-1 and 314-2 may be incident on one surface of the transparent members 320 and 330. Light incident on one surface of the transparent members 320 and 330 may be transferred to the user through the waveguides 320-1 and 330-1 positioned inside the transparent members 320 and 330. The waveguides 320-1 and 330-1 may be made of glass, plastic, or polymer and include a nano-pattern formed on one internal or external surface.

For example, the nano-pattern may include a grating structure having a polygonal or curved shape. According to an embodiment, light incident on one surface of the transparent members 320 and 330 may be propagated or reflected from the inside of the waveguides 320-1 and 330-1 by the nano-pattern to be transferred to the user. According to an embodiment, the waveguides 320-1 and 330-1 may include at least one of a diffractive element (e.g., diffractive optical element (DOE) or holographic optical element (HOE)) or a reflective element (e.g., reflective mirror).

According to an embodiment, the waveguides 320-1 and 330-1 may guide light emitted from the display modules 314-1 and 314-2 to the user's eye using at least one diffractive element or reflective element.

According to an embodiment, the electronic device 300 may include a photographing camera module 313 (e.g., red, green, and blue (RGB) camera module) for photographing an image corresponding to a user's FoV and/or for measuring a distance to an object, eye tracking camera modules 312-1 and 312-2 for identifying a direction of a user's gaze, and/or gesture camera modules 311-1 and 311-2 for recognizing a certain space.

For example, the photographing camera module 313 may photograph a front direction of the electronic device 300, and the eye tracking camera modules 312-1 and 312-2 may photograph a direction opposite to a photographing direction of the photographing camera module 313. For example, the first eye tracking camera module 312-1 may partially photograph a user's left eye, and the second eye tracking camera module 312-2 may partially photograph a user's right eye.

According to an embodiment, the photographing camera module 313 may include a high resolution (HR) camera module such as an HR camera module and/or a photo video (PV) camera module. According to an embodiment, the eye tracking camera modules 312-1 and 312-2 may detect the user's pupils to track a gaze direction. The tracked gaze direction may be utilized to move the center of a virtual image including a virtual object to correspond to the gaze direction.

According to an embodiment, the gesture camera modules 311-1 and 311-2 may detect a user gesture and/or a certain space within a configured distance (e.g., certain space). The gesture camera modules 311-1 and 311-2 may include a camera module including a global shutter (GS). For example, the gesture camera modules 311-1 and 311-2 may be a camera module including a GS in which a rolling shutter (RS) phenomenon may be reduced in order to detect and track rapid hand movements and/or fine movements such as fingers.

According to an embodiment, the electronic device 300 may detect an eye corresponding to a dominant eye and/or an auxiliary eye among the left eye and/or the right eye using at least one camera modules 311-1, 311-2, 312-1, 312-2, and 313. For example, the electronic device 300 may detect an eye corresponding to a dominant eye and/or an auxiliary eye based on a direction of the user's gaze toward an external object or a virtual object.

The number and position of at least one camera module (e.g., the photographing camera module 313, eye tracking camera modules 312-1 and 312-2, and/or gesture camera modules 311-1 and 311-2) included in the electronic device 300 illustrated in FIG. 3A may not be limited. For example, the number and position of at least one camera module (e.g., the photographing camera module 313, eye tracking camera modules 312-1 and 312-2, and/or gesture camera modules 311-1 and 311-2) may be variously changed based on the form (e.g., shape or size) of the electronic device 300.

According to an embodiment, the electronic device 300 may include at least one light emitting device (illumination LED) (e.g., a first light emitting device 342-1, a second light emitting device 342-2) for increasing accuracy of at least one camera module (e.g., the photographing camera module 313, eye tracking camera modules 312-1 and 312-2, and/or gesture camera modules 311-1 and 311-2). For example, the first light emitting device 342-1 may be disposed at a portion corresponding to the user's left eye, and the second light emitting device 342-2 may be disposed at a portion corresponding to the user's right eye.

According to an embodiment, the light emitting devices 342-1 and 342-2 may be used as an auxiliary means for increasing accuracy when photographing a user's pupil with the eye tracking camera modules 312-1 and 312-2, and include an IR LED that generates light of an infrared wavelength. Further, the light emitting devices 342-1 and 342-2 may be used as an auxiliary means when photographing a user's gesture with the gesture camera modules 311-1 and 311-2 or when it is not easy to detect a subject to be photographed due to a dark environment or mixing and reflection of multiple light sources.

According to an embodiment, the electronic device 300 may include a microphone (not illustrated) for receiving a user's voice and ambient sounds. For example, the microphone may be a component included in the audio module 170 of FIG. 1. The microphone may include a first microphone 341-1, a second microphone 341-2, a third microphone 341-3, and/or a fourth microphone 341-4 of FIGS. 3C, 3D, and/or 3E.

According to an embodiment, the first support part 321 and/or the second support part 322 may include a printed circuit board (PCB) (e.g., a first PCB 331-1 or a second PCB 331-2), a speaker (e.g., a first speaker 332-1 or a second speaker 332-2), and/or a battery (e.g., a first battery 333-1 or a second battery 333-2).

According to an embodiment, the speakers 332-1 and 332-2 may include a first speaker 332-1 for transferring an audio signal to the user's left ear and a second speaker 332-2 for transferring an audio signal to the user's right ear. The speakers 332-1 and 332-2 may be components included in the audio module 170 of FIG. 1.

According to an embodiment, the electronic device 300 may be equipped with a plurality of batteries 333-1 and 333-2 and supply power to the PCBs 331-1 and 331-2 through a power management module (e.g., the power management module 188 of FIG. 1). For example, the plurality of batteries 333-1 and 333-2 may be electrically connected to the power management module (e.g., the power management module 188 of FIG. 1).

In the above description, it has been described that the electronic device 300 is a device displaying augmented reality, but the electronic device 300 may be a device displaying virtual reality (VR). In this case, the transparent members 320 and 330 may be made of an opaque material so that the user cannot recognize an actual space through the transparent members 320 and 330. Further, the transparent members 320 and 330 may function as the display module 160. For example, the transparent members 320 and 330 may include a display panel displaying information.

According to an embodiment, the first gesture camera module 311-1 and the second gesture camera module 311-2 may photograph the front to generate an image. According to an embodiment, the first gesture camera module 311-1 and the second gesture camera module 311-2 may each have a field of view (FOV) of 0. According to an embodiment, an image photographed by the first gesture camera module 311-1 and an image photographed by the second gesture camera module 311-2 may have a disparity corresponding to a distance between the first gesture camera module 311-1 and the second gesture camera module 311-2 corresponding to the first gesture camera module 311-1 and the second gesture camera module 311-2 photographing the same subject.

According to an embodiment, the electronic device 300 may include a distance sensor (not illustrated). For example, the distance sensor may measure a distance to a subject in a time of flight (TOF) manner. According to an embodiment, the distance sensor may include an emitter that outputs light particles and a sensor that acquires light particles reflected from a subject after being output from the emitter. For example, the distance sensor may measure a distance based on a flight time required for light or radio waves output therefrom to be reflected from another subject and to be returned. For example, the distance sensor may determine a distance to the subject by multiplying a flight time by a speed of light and dividing it in half. For example, the distance sensor may measure a distance based on an amount of light that has entered the light receiver. The distance sensor may determine that a distance is longer when an amount of light received by the light receiver is less, and that a distance is shorter when an amount of light received by the distance sensor is more. For example, the distance sensor may measure a distance based on a phase change of light acquired from the light receiver.

FIG. 3B is a block diagram illustrating an electronic device according to an embodiment of the disclosure.

Referring to FIG. 3B, the electronic device 300 (e.g., the electronic device 101 of FIG. 1, and/or the electronic device 300 of FIG. 3A) may include a microphone 341, a codec 350, a processor 360, and/or a sensor 380.

Components included in FIG. 3B are for some of the components included in the electronic device 300, and the electronic device 300 may include various components as illustrated in FIG. 1, FIG. 2, and/or FIG. 3A.

The microphone 341 according to an embodiment may include a first microphone 341-1, a second microphone 341-2, a third microphone 341-3, and/or a fourth microphone 341-4. According to an embodiment, the first microphone 341-1, the second microphone 341-2, the third microphone 341-3, and/or the fourth microphone 341-4 may be disposed symmetrically about the electronic device. A detail description regarding the disposition of the microphones 341 will be described later in the description related to FIGS. 3C to 3E.

According to an embodiment, the first microphone 341-1 may correspond to a first input channel, the second microphone 341-2 may correspond to a second input channel, the third microphone 341-3 may correspond to a third input channel, and the fourth microphone 341-4 may correspond to a fourth input channel.

According to an embodiment, the codec 350 may change an analog sound signal received from the microphone 341 into a digital sound signal and transfer the digital sound signal to the processor 360.

According to an embodiment, the sensor 380 may be a sensor that detects a vibration. For example, the sensor 380 may detect a vibration of a designated pattern at the moment when a user wearing the electronic device speaks.

A detail description regarding a disposition of the sensor 380 will be described later in the description related to FIGS. 3C to 3E.

According to an embodiment, the processor 360 may process an input sound acquired by the microphone 341 to generate an output sound.

According to an embodiment, the processor 360 may include a mixer 361, a beamformer 362, a voice detector 363, and/or an output audio controller 364.

According to an embodiment, the mixer 361 may preprocess the input sound. For example, the mixer 361 may amplify the input sound and/or perform equalization (EQ) processing that changes frequency characteristics of the input sound.

According to an embodiment, the beamformer 362 may amplify a sound of a designated direction. For example, the beamformer 362 may amplify a sound received from a designated direction based on beamforming filter parameters corresponding to the designated direction.

According to an embodiment, the voice detector 363 may track a position of a target object generating a sound based on a cross spectral phase difference of each sound generated according to a disposition constitution of the microphone 341. For example, the voice detector 363 may track a position of a target object generating a sound using a generalized cross correlation phase transform (GCC-PHAT) algorithm.

According to an embodiment, the voice detector 363 may detect a voice corresponding to the sensor 380 detecting a vibration.

According to an embodiment, the output audio controller 364 may combine and/or divide sounds to generate an output sounds.

FIGS. 3C to 3E are diagrams illustrating different dispositions of a plurality of microphones and sensors in the electronic device according to various embodiments of the disclosure.

The number and position of at least one microphone 341 and/or sensor 380 included in the electronic device 300 illustrated in FIGS. 3C to 3E may not be limited.

Referring to FIG. 3C, the electronic device 300 according to an embodiment may include four microphones 341-1, 341-2, 341-3, and 341-4 and one sensor 380.

According to an embodiment, the electronic device 300 may include a first microphone 341-1, a second microphone 341-2, a third microphone 341-3, and/or a fourth microphone 341-4.

According to an embodiment, the first microphone 341-1, the second microphone 341-2, the third microphone 341-3, and/or the fourth microphone 341-4 may be disposed symmetrically left and right based on a central axis 1000 of the electronic device 300. For example, the first microphone 341-1 may be disposed at a left front surface (e.g., the first hinge part 340-1) of the electronic device 300, and the third microphone 341-3 may be disposed at a right front surface (e.g., the second hinge part 340-2) of the electronic device 300 to be disposed symmetrically left and right based on the central axis 1000 of the electronic device 300. For example, the second microphone 341-2 may be disposed at a left rear surface (e.g., the first support part 321) of the electronic device 300, and the fourth microphone 341-4 may be disposed at a right rear surface (e.g., the second support part 322) of the electronic device 300 to be disposed symmetrically left and right based on the central axis 1000 of the electronic device 300.

According to an embodiment, the first microphone 341-1, the second microphone 341-2, the third microphone 341-3, and/or the fourth microphone 341-4 may be disposed to be spaced apart by a designated distance. For example, the first microphone 341-1 and the third microphone 341-3 may be disposed to be spaced apart by a designated distance (e.g., 0.12 m to 0.16 m). For example, the first microphone 341-1 and the second microphone 341-2 may be disposed to be spaced apart by a designated distance (e.g., about 0.08 m to about 0.12 m). For example, the third microphone 341-3 and the fourth microphone 341-4 may be disposed to be spaced apart by a designated distance (e.g., about 0.08 m to about 0.12 m). For example, the second microphone 341-2 and the fourth microphone 341-4 may be disposed to be spaced apart by a designated distance (e.g., about 0.12 m to about 0.16 m).

By disposing a plurality of microphones as described above, the electronic device 300 may receive sounds by distinguishing between the left and the right, and the front surface and the rear surface.

Further, by disposing a plurality of microphones as described above, the electronic device 300 may form a beam of a designated band (e.g., about 1.0 kHz to about 2.1 kHz) to perform a beamforming operation in a designated direction.

According to an embodiment, the electronic device 300 may include a sensor 380.

According to an embodiment, the sensor 380 may be disposed at the front center (e.g., the main body 323) of the electronic device 300. For example, the sensor 380 may be disposed at a position where the user's vocal cord vibration is physically transferred, as in near a nose pad of the main body 323.

Referring to FIG. 3D, the electronic device 300 according to an embodiment may include five microphones and three sensors 380.

According to an embodiment, the electronic device 300 may include a first microphone 341-1, a second microphone 341-2, a third microphone 341-3, a fourth microphone 341-4, and/or a fifth microphone 341-5.

According to an embodiment, the first microphone 341-1, the second microphone 341-2, the third microphone 341-3, and/or the fourth microphone 341-4 may be disposed symmetrically left and right based on the central axis 1000 of the electronic device 300. For example, the first microphone 341-1 may be disposed at a left front surface (e.g., the first hinge part 340-1) of the electronic device 300, and the third microphone 341-3 may be disposed at a right front surface (e.g., the second hinge part 340-2) of the electronic device 300 to be disposed symmetrically left and right based on the central axis 1000 of the electronic device 300. For example, the second microphone 341-2 may be disposed at a left rear surface (e.g., the first support part 321) of the electronic device 300, and the fourth microphone 341-4 may be disposed at a right rear surface (e.g., the second support part 322) of the electronic device 300 to be disposed symmetrically left and right based on the central axis 1000 of the electronic device 300.

According to an embodiment, the first microphone 341-1, the second microphone 341-2, the third microphone 341-3, and/or the fourth microphone 341-4 may be disposed to be spaced apart by a designated distance. For example, the first microphone 341-1 and the third microphone 341-3 may be disposed to be spaced apart by a designated distance (e.g., about 0.12 m to about 0.16 m). For example, the first microphone 341-1 and the second microphone 341-2 may be disposed to be spaced apart by a designated distance (e.g., about 0.08 m to about 0.12 m). For example, the third microphone 341-3 and the fourth microphone 341-4 may be disposed to be spaced apart by a designated distance (e.g., about 0.08 m to about 0.12 m). For example, the second microphone 341-2 and the fourth microphone 341-4 may be disposed to be spaced apart by a designated distance (e.g., about 0.12 m to about 0.16 m).

According to an embodiment, the fifth microphone may be disposed at the front center (e.g., the main body 323) of the electronic device 300.

By disposing a plurality of microphones as described above, the electronic device 300 may perform a sound collection operation that may distinguish between the left and the right, the front surface and the rear surface.

Further, by disposing a plurality of microphones as described above, the electronic device 300 may form a beam of a designated band (e.g., about 1.0 kHz to about 2.1 kHz) to perform a beamforming operation.

According to an embodiment, the electronic device 300 may include a first sensor 380-1, a second sensor 380-2, and/or a third sensor 380-3.

According to an embodiment, the first sensor 380-1 may be disposed at the front center (e.g., the main body 323) of the electronic device 300. For example, the first sensor 380-1 may be disposed at a position where the user's vocal cord vibration is physically transferred, as in near a nose pad of the main body 323.

According to an embodiment, the second sensor 380-2 may be disposed at a left rear surface (e.g., the first support part 321) of the electronic device 300. For example, the second sensor 380-2 may be disposed at a position where the user's vocal cord vibration is physically transferred, as in near a temple of glasses of the first support part 321.

According to an embodiment, the third sensor 380-3 may be disposed at a right rear surface (e.g., the second support part 322) of the electronic device 300. For example, the third sensor 380-3 may be disposed at a position where the user's vocal cord vibration is physically transferred, as in near a temple of glasses of the second support part 322.

Referring to FIG. 3E, the electronic device 300 according to an embodiment may include three microphones and two sensors 380.

According to an embodiment, the electronic device 300 may include a second microphone 341-2, a fourth microphone 341-4, and/or a fifth microphone 341-5.

According to an embodiment, the second microphone 341-2 and/or the fourth microphone 341-4 may be disposed symmetrically left and right based on the central axis 1000 of the electronic device 300. For example, the second microphone 341-2 may be disposed at a left rear surface (e.g., the first support part 321) of the electronic device 300, and the fourth microphone 341-4 may be disposed at a right rear surface (e.g., the second support part 322) of the electronic device 300 to be disposed symmetrically left and right based on the central axis 1000 of the electronic device 300.

According to an embodiment, the second microphone 341-2, the fourth microphone 341-4, and/or the fifth microphone 341-5 may be disposed to be spaced apart by a designated distance. For example, the second microphone 341-2 and the fourth microphone 341-4 may be disposed to be spaced apart by a designated distance (e.g., about 0.12 m to about 0.16 m). For example, the second microphone 341-2 and the fifth microphone 341-5 may be disposed to be spaced apart by a designated distance (e.g., about 0.12 m to about 0.18 m). For example, the fourth microphone 341-4 and the fifth microphone 341-5 may be disposed to be spaced apart by a designated distance (e.g., about 0.12 m to about 0.18 m).

According to an embodiment, the fifth microphone 341-5 may be disposed at the front center (e.g., the main body 323) of the electronic device 300.

By disposing a plurality of microphones 341 as described above, the electronic device 300 may perform a sound receiving operation that may distinguish between the left and the right, the front surface and the rear surface.

Further, by disposing a plurality of microphones 341 as described above, the electronic device 300 may form a beam of a designated band (e.g., about 1.0 kHz to about 2.1 kHz) to perform a beamforming operation.

According to an embodiment, the electronic device 300 may include a first sensor 380-1 and/or a second sensor 380-2.

According to an embodiment, the first sensor 380-1 may be disposed at the front center (e.g., the main body 323) of the electronic device 300. For example, the first sensor 380-1 may be disposed at a position where the user's vocal cord vibration is physically transferred, as in near a nose pad of the main body 323.

According to an embodiment, the second sensor 380-2 may be disposed at a left rear surface (e.g., the first support part 321) of the electronic device 300. For example, the second sensor 380-2 may be disposed at a position where the user's vocal cord vibration is physically transferred, as in near a temple of glasses of the first support part 321.

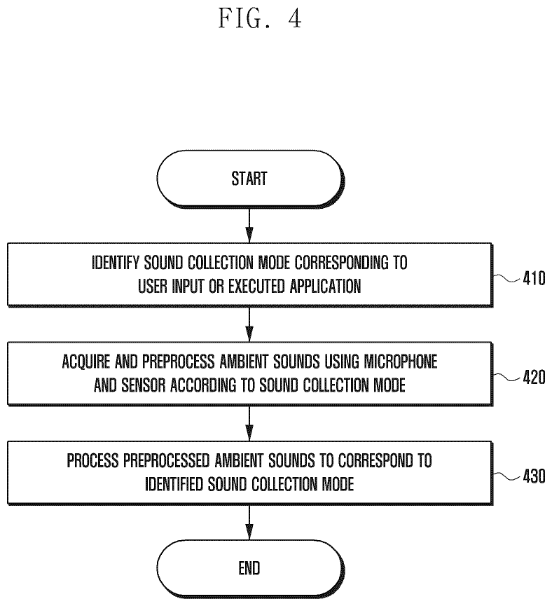

FIG. 4 is a flowchart illustrating a method in which a processor operates in a sound collection mode according to an embodiment of the disclosure.

Referring to FIG. 4, at operation 410, the processor 360 may identify a sound collection mode corresponding to a user input or an executed application.

For example, the user may select a sound collection mode through the electronic device 300 and/or an external electronic device. The user input may include executing a designated application, making a call, recording, and/or recognizing a voice.

According to an embodiment, the sound collection mode may include a first mode, a second mode, and/or a third mode. For example, the first mode may be an immersive recording mode. For example, the second mode may be a directive beamforming mode. For example, the third mode may be a user voice enhancement mode.

According to an embodiment, at operation 420, the processor 360 may acquire and preprocess a sound using the microphone 341 and/or the sensor 380 according to the sound collection mode.

According to an embodiment, sounds acquired using the microphone 341 and/or the sensor 380 may include ambient sounds, the user's sounds, and/or sounds of speakers in front of the user.

According to an embodiment, the processor 360 may preprocess sounds acquired by input channels corresponding to the first microphone 341-1, the second microphone 341-2, the third microphone 341-3, and/or the fourth microphone 341-4. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone). The processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may detect a sound using the sensor 380. For example, the processor 360 may determine that the user is speaking and detect the user's sound corresponding to the sensor 380 detecting a vibration of a designated pattern.

According to an embodiment, at operation 430, the processor 360 may process the preprocessed sound to correspond to the identified sound collection mode.

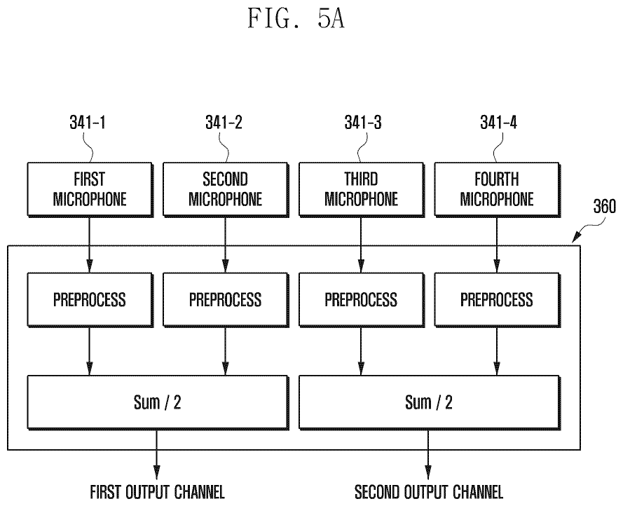

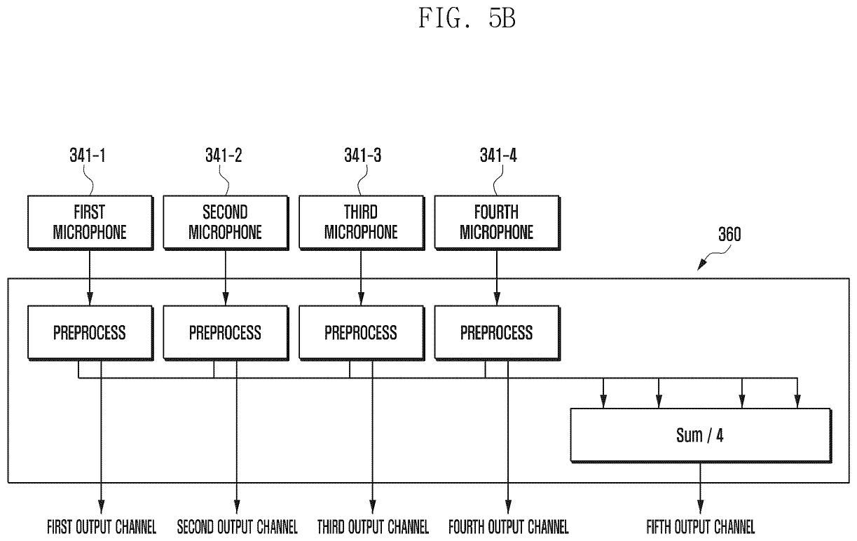

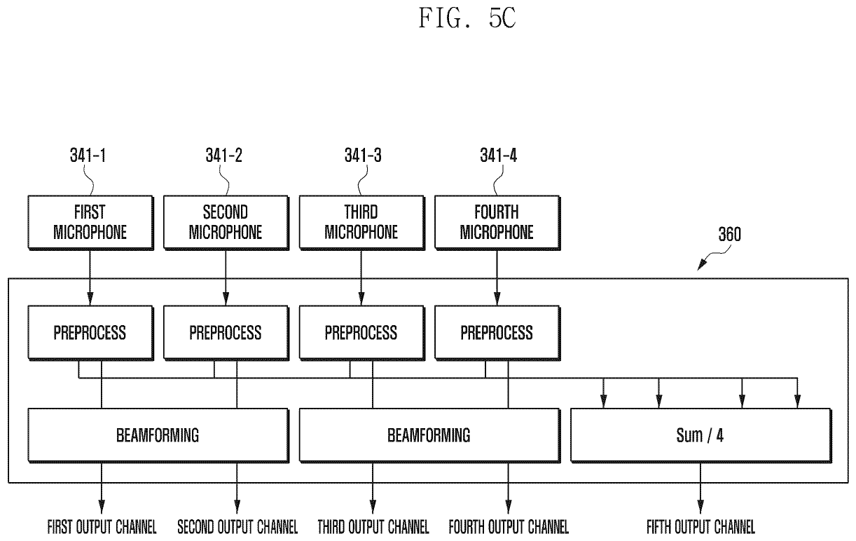

According to an embodiment, in the first mode, the processor 360 may generate a sound of stereo channels and/or a sound of 5.1 channel based on the preprocessed sound. A detailed description regarding an operation of the first mode will be described later in the description related to FIGS. 5A to 5D.

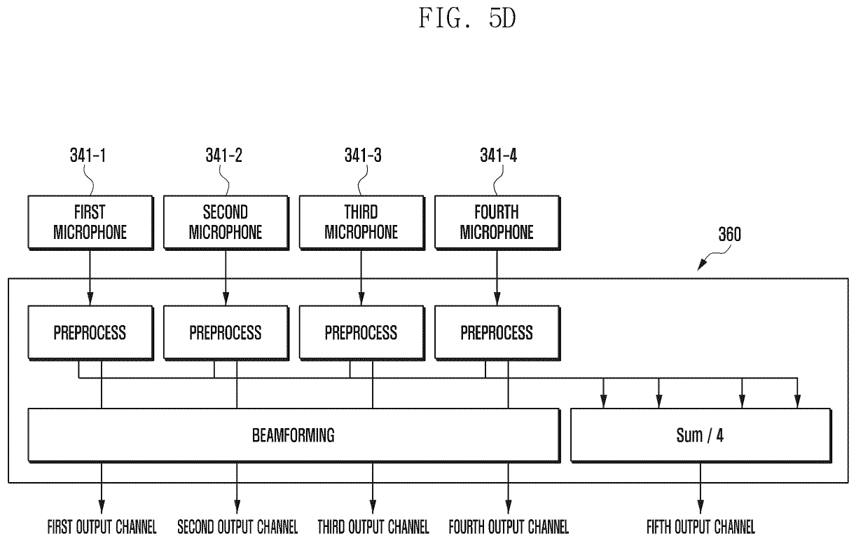

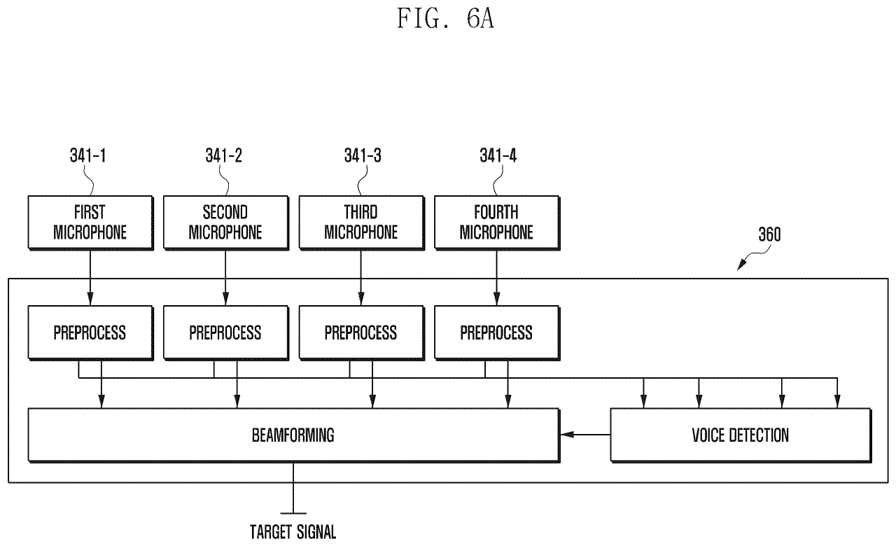

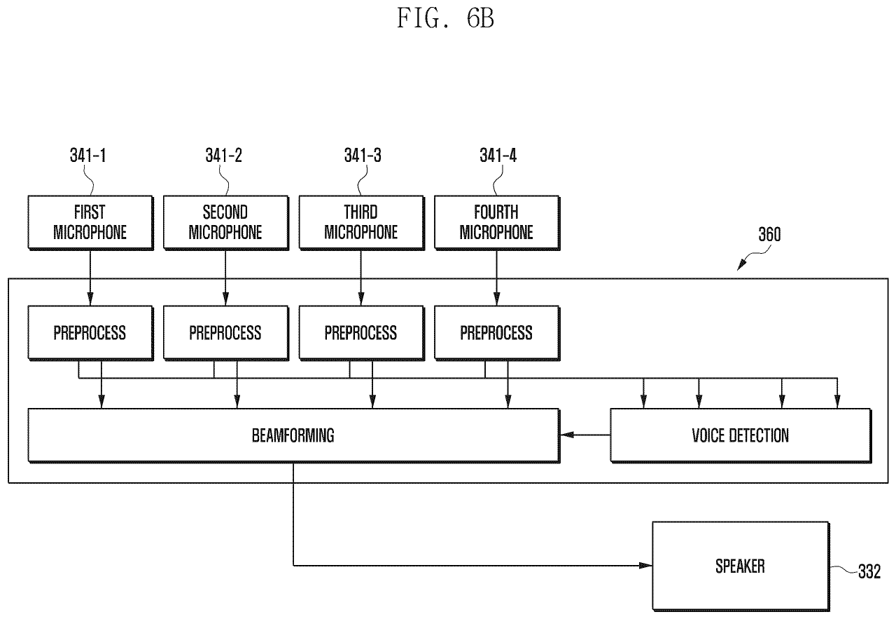

According to an embodiment, in the second mode, the processor 360 may amplify and collect a sound of a designated direction using beamforming based on the preprocessed sound. A detailed description regarding an operation of the second mode will be described later in the description related to FIGS. 6A and 6B.

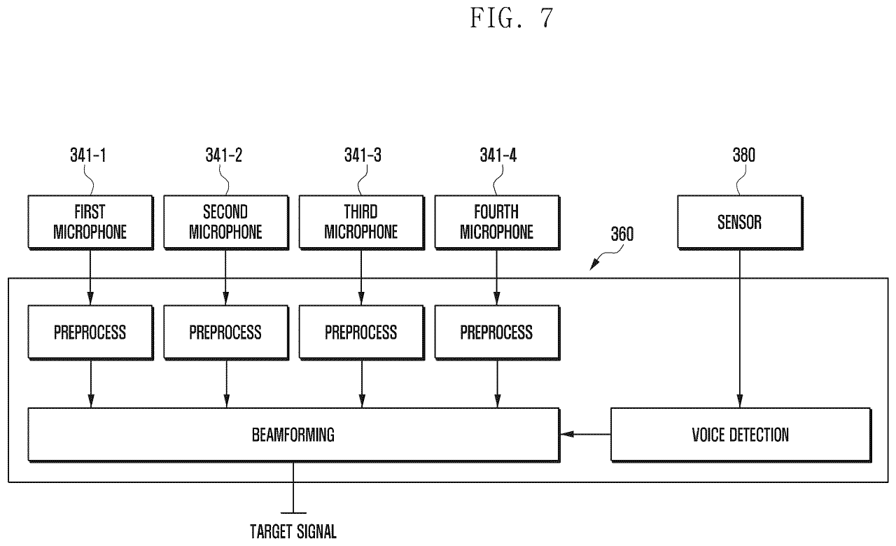

According to an embodiment, in the third mode, the processor 360 may amplify and receive the user's sound using the sensor 380 and beamforming based on the preprocessed sound. A detailed description regarding an operation of the third mode will be described later in the description related to FIG. 7.

According to an embodiment, the processor 360 may output a sound received by operating in the first mode, the second mode, and/or the third mode through the speaker.

According to an embodiment, the processor 360 may process and store each of ambient sounds, user sounds, or sounds of a speaker in front of the user during recording.

According to an embodiment, the processor 360 may receive and simultaneously process a sound to output the sound through the speaker.

According to an embodiment, in the second mode, the processor 360 may acquire sounds generated by external objects in a direction of beamforming among ambient sounds, amplify the sounds, and output the sounds through the speaker.

According to an embodiment, in the second mode, the processor 360 may determine a beamforming direction using the eye tracking camera module (e.g., the first eye tracking camera module 312-1 and the second eye tracking camera module 312-2 of FIG. 3A).

According to an embodiment, the processor 360 may collect a sound and simultaneously determine a beamforming direction at a designated period to collect a sound of the determined direction.

FIGS. 5A to 5D are block diagrams illustrating a processor operating in a first mode according to various embodiments of the disclosure.

According to an embodiment, the first mode may be an immersive recording mode.

FIG. 5A is a block diagram related to processing for generating a sound of stereo channels in a first mode by the processor 360 according to an embodiment of the disclosure.

Referring to FIG. 5A, the processor 360 may generate a sound of a first output channel based on the sound of the input channel corresponding to the first microphone 341-1 and/or the second microphone 341-2.

According to an embodiment, the processor 360 may preprocess the sound of the input channel corresponding to the first microphone 341-1 and/or the second microphone 341-2. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone).

According to an embodiment, the processor 360 may generate a sound of a first output channel using the preprocessed sound. For example, the processor 360 may combine the preprocessed sound of the first input channel and the preprocessed sound of the second input channel and divide the combined sound by a designated value (e.g., 2) to generate a sound of a first output channel.

According to an embodiment, the processor 360 may generate a sound of a second output channel based on the sound of the input channel corresponding to the third microphone 341-3 and/or the fourth microphone 341-4.

According to an embodiment, the processor 360 may preprocess the sound of the input channel corresponding to the third microphone 341-3 and/or the fourth microphone 341-4. For example, the processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may generate a sound of a second output channel using the preprocessed sound. For example, the processor 360 may combine the preprocessed sound of the third input channel and the preprocessed sound of the fourth input channel and divide the combined sound by a designated value (e.g., 2) to generate a sound of a second output channel.

FIG. 5B is a block diagram related to signal processing for generating 5.1 channel sound in a first mode by a processor according to an embodiment of the disclosure.

Referring to FIG. 5B, the processor 360 may generate a sound of a first output channel based on the sound of the first input channel corresponding to the first microphone 341-1.

According to an embodiment, the processor 360 may preprocess the sound of the first input channel corresponding to the first microphone 341-1 and generate a sound of a first output channel using the preprocessed signal. For example, the processor 360 may amplify and/or equalize (EQ) the sound of the first input channel corresponding to the first microphone 341-1 (e.g., left front microphone) to generate a sound of a first output channel.

According to an embodiment, the processor 360 may generate a sound of a second output channel based on the sound of the second input channel corresponding to the second microphone 341-2.

According to an embodiment, the processor 360 may preprocess the sound of the second input channel corresponding to the second microphone 341-2 and generate a sound of a second output channel using the preprocessed sound. For example, the processor 360 may amplify and/or equalize (EQ) the signal of the second input channel corresponding to the second microphone 341-2 (e.g., left rear microphone) to generate a sound of a second output channel.

According to an embodiment, the processor 360 may generate a sound of a third output channel based on the sound of the third input channel corresponding to the third microphone 341-3.

According to an embodiment, the processor 360 may preprocess the sound of the third input channel corresponding to the third microphone 341-3 and generate a sound of a third output channel using the preprocessed sound. For example, the processor 360 may amplify and/or equalize (EQ) the sound of the third input channel corresponding to the third microphone 341-3 (e.g., right front microphone) to generate a sound of a third output channel.

According to an embodiment, the processor 360 may generate a sound of a fourth output channel based on the sound of the fourth input channel corresponding to the fourth microphone 341-4. According to an embodiment, the processor 360 may preprocess the sound of the fourth input channel corresponding to the fourth microphone 341-4 and generate a sound of a fourth output channel using the preprocessed sound. For example, the processor 360 may amplify and/or equalize (EQ) the sound of the fourth input channel corresponding to the fourth microphone 341-4 (e.g., right rear microphone) to generate a sound of a fourth output channel.

According to an embodiment, the processor 360 may generate a sound of a fifth output channel based on the sound of input channels corresponding to the first microphone 341-1, the second microphone 341-2, the third microphone 341-3, and/or the fourth microphone 341-4.

According to an embodiment, the processor 360 may preprocess the sounds of the first input channel corresponding to the first microphone 341-1, the second input channel corresponding to the second microphone 341-2, the third input channel corresponding to the third microphone 341-3, and/or the fourth input channel corresponding to the fourth microphone 341-4, and generate a sound of a fifth output channel using the preprocessed sounds. For example, the processor 360 may combine the preprocessed sound of the first input channel, the preprocessed sound of the second input channel, the preprocessed sound of the third input channel, and the preprocessed sound of the fourth input channel and divide the combined sound by a designated value (e.g., 4) to generate a sound of the fifth output channel.

FIG. 5C is a block diagram related to signal processing for generating 5.1 channel sound directed in two designated directions using beamforming in a first mode by a processor according to an embodiment of the disclosure.

Referring to FIG. 5C, the processor 360 may generate a sound of a first output channel based on the sound of the first input channel corresponding to the first microphone 341-1, and generate a sound of a second output channel based on the sound of the second input channel corresponding to the second microphone 341-2.

According to an embodiment, the processor 360 may preprocess the sound of the input channel corresponding to the first microphone 341-1 and/or the second microphone 341-2. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone).

According to an embodiment, the processor 360 may perform beamforming processing on the preprocessed sound in a configured direction (e.g., left direction) to generate sounds of a first output channel and/or a second output channel directed in a designated direction. For example, the processor 360 may perform beamforming processing on the preprocessed sound of the first input channel and the preprocessed sound of the second input channel to direct them in a first direction (e.g., left direction) to generate a sound of a first output channel and a sound of a second output channel.

According to an embodiment, the processor 360 may generate a sound of a third output channel based on the sound of the third input channel corresponding to the third microphone 341-3, and generate a sound of a fourth output channel based on the sound of the fourth input channel corresponding to the fourth microphone 341-4.

According to an embodiment, the processor 360 may preprocess the sound of the input channel corresponding to the third microphone 341-3 and/or the fourth microphone 341-4. For example, the processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may perform beamforming processing on the preprocessed sound in a configured direction (e.g., right direction) to generate sounds of a third output channel and/or a fourth output channel directed in a designated direction. For example, the processor 360 may perform beamforming processing on the preprocessed sound of the third input channel and the preprocessed sound of the fourth input channel to direct them in a second direction (e.g., right direction) to generate a sound of a third output channel and a sound of a fourth output channel.

According to an embodiment, the processor 360 may generate a sound of a fifth output channel based on the sound of input channels corresponding to the first microphone 341-1, the second microphone 341-2, the third microphone 341-3, and/or the fourth microphone 341-4.

According to an embodiment, the processor 360 may generate a sound of a fifth output channel using the preprocessed sound of the first input channel, the preprocessed sound of the second input channel, the preprocessed sound of the third input channel, and/or the preprocessed sound of the fourth input channel. For example, the processor 360 may combine the preprocessed sound of the first input channel, the preprocessed sound of the second input channel, the preprocessed sound of the third input channel, and the preprocessed sound of the fourth input channel and divide the combined sound by a designated value (e.g., 4) to generate a sound of a fifth output channel.

FIG. 5D is a block diagram related to signal processing for generating 5.1 channel sound directed in four designated directions using beamforming in a first mode by the processor 360 according to an embodiment of the disclosure.

Referring to FIG. 5D, the processor 360 may generate a sound of a first output channel based on the sound of the first input channel corresponding to the first microphone 341-1, generate a sound of a second output channel based on the sound of the second input channel corresponding to the second microphone 341-2, generate a sound of a third output channel based on the sound of the third input channel corresponding to the third microphone 341-3, and generate a sound of a fourth output channel based on the sound of the fourth input channel corresponding to the fourth microphone 341-4.

According to an embodiment, the processor 360 may preprocess the sound of input channels corresponding to the first microphone 341-1, the second microphone 341-2, the third microphone 341-3, and/or the fourth microphone 341-4. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone). The processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may perform beamforming processing on the preprocessed sound to generate sounds of a first output channel, a second output channel, a third output channel, and/or a fourth output channel directed in a designated direction. For example, the processor 360 may perform beamforming processing on the preprocessed sound of the first input channel to direct it in a first direction (e.g., left front direction) to generate a sound of a first output channel. For example, the processor 360 may perform beamforming processing on the preprocessed sound of the second input channel to direct it in a second direction (e.g., left rear direction) to generate a sound of a second output channel. For example, the processor 360 may perform beamforming processing on the preprocessed sound of the third input channel to direct it in a third direction (e.g., right front direction) to generate a sound of a third output channel. For example, the processor 360 may perform beamforming processing on the preprocessed sound of the fourth input channel to direct it in a fourth direction (e.g., right rear direction) to generate a sound of a fourth output channel.

According to an embodiment, the processor 360 may generate a sound of a fifth output channel based on the sound of the input channel corresponding to the first microphone 341-1, the second microphone 341-2, and the third microphone 341-3 and/or the fourth microphone 341-4.

According to an embodiment, the processor 360 may preprocess sounds of a first input channel corresponding to the first microphone 341-1, a second input channel corresponding to the second microphone 341-2, a third input channel corresponding to the third microphone 341-3, and/or a fourth input channel corresponding to the fourth microphone 341-4, and generate a sound of a fifth output channel using the preprocessed sounds. For example, the processor 360 may combine the preprocessed sound of the first input channel, the preprocessed sound of the second input channel, the preprocessed sound of the third input channel, and the preprocessed sound of the fourth input channel and divide the combined sound by a designated value (e.g., 4) to generate a sound of the fifth output channel.

FIGS. 6A and 6B are block diagrams illustrating a processor operating in a second mode according to various embodiments of the disclosure.

According to an embodiment, the second mode may be a directive beamforming sound collection mode.

FIG. 6A is a block diagram related to signal processing for collecting a sound of a designated direction using beamforming in a second mode by the processor 360 according to an embodiment of the disclosure.

Referring to FIG. 6A, the processor 360 may collect a sound of a designated direction based on the sound of the first input channel corresponding to the first microphone 341-1, the sound of the second input channel corresponding to the second microphone 341-2, the sound of the third input channel corresponding to the third microphone 341-3, and/or the sound of the fourth input channel corresponding to the fourth microphone 341-4.

According to an embodiment, the processor 360 may preprocess the sound of input channels corresponding to the first microphone 341-1, the second microphone 341-2, the third microphone 341-3, and/or the fourth microphone 341-4. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone). The processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may detect a sound based on the preprocessed sound.

For example, the processor 360 may track a position of a target object generating a sound based on a cross-spectral phase difference of each sound generated according to a disposition constitution of the first microphone 341-1, the second microphone 341-2, the third microphone 341-3, and/or the fourth microphone 341-4. For example, the processor 360 may track a position of a target object generating a sound using a generalized cross correlation phase transform (GCC-PHAT) algorithm.

According to an embodiment, the processor 360 may determine a designated direction to perform beamforming based on the position of the tracked target object. For example, the processor 360 may determine parameters of a beamforming filter corresponding to the designated direction.

According to an embodiment, the processor 360 may collect a sound of a designated direction using beamforming based on the preprocessed sound.

For example, the processor 360 may amplify and collect a sound received from a designated direction using a beamforming filter based on the preprocessed sound of the first input channel, the preprocessed sound of the second input channel, the preprocessed sound of the third input channel, and/or the preprocessed sound of the fourth input channel.

FIG. 6B is a block diagram related to signal processing for collecting a sound of a designated direction using beamforming in a second mode and outputting the received voice sound by a processor according to an embodiment of the disclosure.

Referring to FIG. 6B, the processor 360 may collect a sound of a designated direction based on the sound of the first input channel corresponding to the first microphone 341-1, the sound of the second input channel corresponding to the second microphone 341-2, the sound of the third input channel corresponding to the third microphone 341-3, and/or the sound of the fourth input channel corresponding to the fourth microphone 341-4.

According to an embodiment, the processor 360 may preprocess the sound of input channels corresponding to the first microphone 341-1, the second microphone 341-2, the third microphone 341-3, and/or the fourth microphone 341-4. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone). The processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may detect a sound based on a preprocessed sound.

For example, the processor 360 may track a position of a target object generating a sound based on a cross-spectral phase difference of each sound generated according to a disposition constitution of the first microphone 341-1, the second microphone 341-2, the third microphone 341-3, and/or the fourth microphone 341-4. For example, the processor 360 may track a position of a target object generating a sound using a generalized cross correlation phase transform (GCC-PHAT) algorithm.

According to an embodiment, the processor 360 may determine a designated direction to perform beamforming based on the position of the tracked target object. For example, the processor 360 may determine parameters of a beamforming filter corresponding to the designated direction.

According to an embodiment, the processor 360 may collect a sound of a designated direction using beamforming based on the preprocessed sound.

For example, the processor 360 may amplify and receive a target sound received in a designated direction using the beamforming filter based on the preprocessed sound of the first input channel, the preprocessed sound of the second input channel, the preprocessed sound of the third input channel, and/or the preprocessed sound of the fourth input channel.

According to an embodiment, the processor 360 may output the received target sound through the speaker 332.

For example, the processor 360 may perform beamforming on and collect a sound (e.g., voice) of a target object and output the sound through the speaker in real time, so that when the user talks to a speaker in front in an environment with noisy surroundings, the user may clearly hear the speaker's voice.

FIG. 7 is a block diagram related to signal processing for collecting a sound of a designated direction using a sensor and beamforming in a third mode by the processor 360 according to an embodiment of the disclosure.

Referring to FIG. 7, the third mode may be a user voice enhancement mode.

According to an embodiment, the processor 360 may collect a sound of a designated direction based on the sound of the first input channel corresponding to the first microphone 341-1, the sound of the second input channel corresponding to the second microphone 341-2, the sound of the third input channel corresponding to the third microphone 341-3, and/or the sound of the fourth input channel corresponding to the fourth microphone 341-4.

According to an embodiment, the processor 360 may preprocess the sound of input channels corresponding to the first microphone 341-1, the second microphone 341-2, the third microphone 341-3, and/or the fourth microphone 341-4. For example, the processor 360 may amplify and/or equalize (EQ) the sound of the first input channel corresponding to the first microphone 341-1 (e.g., left front microphone). The processor 360 may amplify and/or equalize (EQ) the sound of the second input channel corresponding to the second microphone 341-2 (e.g., left rear microphone). The processor 360 may amplify and/or equalize (EQ) the sound of the third input channel corresponding to the third microphone 341-3 (e.g., right front microphone). The processor 360 may amplify and/or equalize (EQ) the sound of the fourth input channel corresponding to the fourth microphone 341-4 (e.g., right rear microphone).

According to an embodiment, the processor 360 may detect a sound using the sensor 380. For example, the processor 360 may determine that the user is speaking and detect the user's sound corresponding to the sensor 380 detecting a vibration of a designated pattern.

According to an embodiment, the processor 360 may collect a sound of a designated direction using beamforming based on the preprocessed sound corresponding to sound detection.

For example, the processor 360 may amplify and detect a target sound received in a designated direction using the beamforming filter based on the preprocessed sound of the first input channel, the preprocessed sound of the second input channel, the preprocessed sound of the third input channel, and/or the preprocessed sound of the fourth input channel. For example, the designated direction may be a direction corresponding to the user's mouth, and the beamforming parameter may be a value corresponding to a direction in which the user's mouth is positioned.

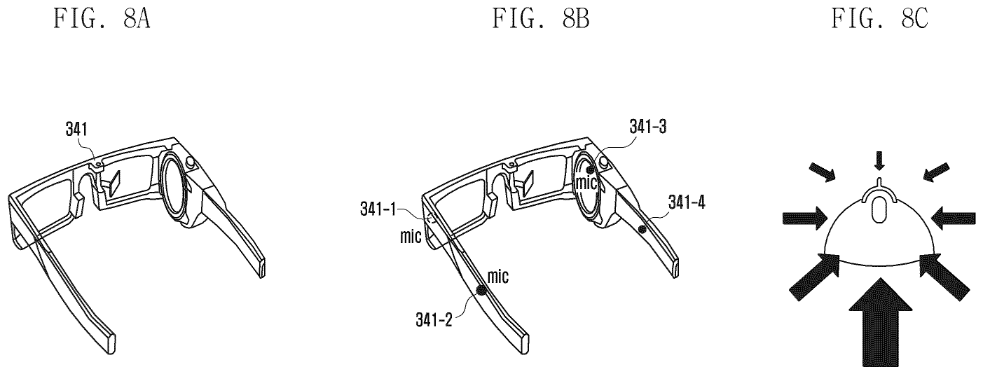

FIGS. 8A, 8B and 8C are diagrams illustrating an example of disposing at least one microphone in an electronic device according to an embodiment of the disclosure.

Referring to FIG. 8A, the microphone 341 may be disposed at an inner surface of the front center (e.g., the main body 323 of FIG. 3A) of the electronic device 300. Accordingly, the main body 323 may protect the microphone 341 from an external environment (e.g., wind), and the microphone 341 may collect a sound reflected from the transparent member (e.g., the first transparent member 320 and/or the second transparent member 330 of FIG. 3A).

Referring to FIG. 8B, the first microphone 341-1 may be disposed at an inner surface of a left front surface (e.g., the first hinge part 340-1) of the electronic device 300, the second microphone 341-2 may be disposed at an inner surface of a left rear surface (e.g., the first support part 321) of the electronic device 300, the third microphone 341-3 may be disposed at an inner surface of a right front surface (e.g., the second hinge part 340-2) of the electronic device 300, and the fourth microphone 341-4 may be disposed at an inner surface of a right rear surface (e.g., the second support part 322) of the electronic device 300. Accordingly, the first hinge part 340-1, the first support part 321, the second hinge part 340-2, and the second support part 322 may protect the first microphone 341-1, the second microphone 341-2, the third microphone 341-3, and/or the fourth microphone 341-4 from an external environment (e.g., wind), and the first microphone 341-1, the second microphone 341-2, the third microphone 341-3, and/or the fourth microphone 341-4 may collect a sound reflected by the transparent member (e.g., the first transparent member 320 and/or the second transparent member 330 of FIG. 3A).

Referring to FIG. 8C, a hole of the microphone 341 may be formed to face downward, and the outside of the hole of the microphone may be implemented as in a dish-shaped antenna to collect the user's voice.

An electronic device according to an embodiment may include a first microphone disposed at a left front surface thereof to collect a sound of a first input channel; a second microphone disposed at a left rear surface thereof to collect a sound of a second input channel; a third microphone disposed at a right front surface thereof to collect a sound of a third input channel; a fourth microphone disposed at a right rear surface thereof to collect a sound of a fourth input channel; and a processor, wherein the processor may be configured to preprocess the sound of the first input channel, the sound of the second input channel, the sound of the third input channel, and the sound of the fourth input channel, to operate in a first mode that records immersive audio based on the preprocessed sound of the first input channel, the preprocessed sound of the second input channel, the preprocessed sound of the third input channel, and the preprocessed sound of the fourth input channel, or to operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

In an electronic device according to an embodiment, the first microphone and the third microphone may be disposed symmetrically about the electronic device while being spaced apart by a first distance, the second microphone and the fourth microphone may be disposed symmetrically about the electronic device while being spaced apart by the first distance, the first microphone and the second microphone may be disposed apart by a second distance, and the third microphone and the fourth microphone may be disposed apart by the second distance.

In an electronic device according to an embodiment, in the first mode, the processor may be configured to combine the preprocessed sound of the first input channel and the preprocessed sound of the second input channel and to divide the combined sound by a designated value to generate a sound of a first output channel, and to combine the preprocessed sound of the third input channel and the preprocessed sound of the fourth input channel, and to divide the combined sound by a designated value to generate a sound of a second output channel.

In an electronic device according to an embodiment, in the first mode, the processor may be configured to generate a sound of a first output channel based on the preprocessed sound of the first input channel, to generate a sound of a second output channel based on the preprocessed sound of the second input channel, to generate a sound of a third output channel based on the preprocessed sound of the third input channel, to generate a sound of a fourth output channel based on the preprocessed sound of the fourth input channel, and to combine the preprocessed sound of the first input channel, the preprocessed sound of the second input channel, the preprocessed sound of the third input channel, and the preprocessed sound of the fourth input channel and to divide the combined sound by a designated value to generate a sound of a fifth output channel.

In an electronic device according to an embodiment, in the first mode, the processor may be configured to perform beamforming processing on the preprocessed sound of the first input channel in a first direction to generate a sound of a first output channel, to perform beamforming processing on the preprocessed sound of the second input channel in the first direction to generate a sound of a second output channel, to perform beamforming processing on the preprocessed sound of the third input channel in a second direction to generate a sound of a third output channel, to perform beamforming processing on the preprocessed sound of the fourth input channel in the second direction to generate a sound of a fourth output channel, and to combine the preprocessed sound of the first input channel, the preprocessed sound of the second input channel, the preprocessed sound of the third input channel, and the preprocessed sound of the fourth input channel and to divide the combined sound by a designated value to generate a sound of a fifth output channel.

In an electronic device according to an embodiment, in the first mode, the processor may be configured to perform beamforming processing on the preprocessed sound of the first input channel in a first direction to generate a sound of a first output channel, to perform beamforming processing on the preprocessed sound of the second input channel in a second direction to generate a sound of a second output channel, to perform beamforming processing on the preprocessed sound of the third input channel in a third direction to generate a sound of a third output channel, to perform beamforming processing on the preprocessed sound of the fourth input channel in a fourth direction to generate a sound of a fourth output channel, and to combine the preprocessed sound of the first input channel, the preprocessed sound of the second input channel, the preprocessed sound of the third input channel, and the preprocessed sound of the fourth input channel and to divide the combined sound by a designated value to generate a sound of a fifth output channel.

In an electronic device according to an embodiment, in the second mode, the processor may be configured to track a position of a target sound based on the preprocessed sound of the first input channel, the preprocessed sound of the second input channel, the preprocessed sound of the third input channel, and the preprocessed sound of the fourth input channel, to determine a designated direction to collect a sound based on the position of the target sound, and to perform beamforming processing on the preprocessed sound of the first input channel, the preprocessed sound of the second input channel, the preprocessed sound of the third input channel, and the preprocessed sound of the fourth input channel in a designated direction to amplify and receive the target sound based on the position of the target sound.

In an electronic device according to an embodiment, the electronic device may further include a speaker, and the processor may be configured to output the amplified and received target sound to the speaker.

In an electronic device according to an embodiment, the electronic device may further include a camera configured to track a user's gaze, and the processor may be configured to determine a designated direction to collect a sound based on the user's gaze tracked by the camera.

In an electronic device according to an embodiment, the electronic device may further include a sensor configured to detect a vibration, and the processor may be configured to operate in a third mode that enhances and receives a user's voice based on the preprocessed sound of the first input channel, the preprocessed sound of the second input channel, the preprocessed sound of the third input channel, and the preprocessed sound of the fourth input channel, and to perform beamforming processing on the preprocessed sound of the first input channel, the preprocessed sound of the second input channel, the preprocessed sound of the third input channel, and the preprocessed sound of the fourth input channel in a preconfigured designated direction to amplify and receive a target sound corresponding to the sensor detecting a vibration of a designated pattern, in the third mode.

In a method of operating an electronic device according to an embodiment, the electronic device may include a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, and a fourth microphone disposed at a right rear surface thereof to collect a sound of a fourth input channel, the electronic device may be configured to preprocess the sound of the first input channel, the sound of the second input channel, the sound of the third input channel, and the sound of the fourth input channel, and to operate in a first mode that records immersive audio based on the preprocessed sound of the first input channel, the preprocessed sound of the second input channel, the preprocessed sound of the third input channel, and the preprocessed sound of the fourth input channel, or to operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

In a method of operating an electronic device according to an embodiment, the first microphone and the third microphone may be disposed symmetrically about the electronic device while being spaced apart by a first distance, the second microphone and the fourth microphone may be disposed symmetrically about the electronic device while being spaced apart by the first distance, the first microphone and the second microphone may be disposed apart by a second distance, and the third microphone and the fourth microphone may be disposed apart by the second distance.

In a method of operating an electronic device according to an embodiment, the operation of the first mode may include an operation of generating a sound of a first output channel by combining the preprocessed sound of the first input channel and the preprocessed sound of the second input channel and dividing the combined sound by a designated value (e.g., 2); and an operation of generating a sound of a second output channel by combining the preprocessed sound of the third input channel and the preprocessed sound of the fourth input channel and dividing the combined sound by a designated value.

In a method of operating an electronic device according to an embodiment, the operation of the first mode may include an operation of generating a sound of a first output channel based on the preprocessed sound of the first input channel; an operation of generating a sound of a second output channel based on the preprocessed sound of the second input channel; an operation of generating a sound of a third output channel based on the preprocessed sound of the third input channel; an operation of generating a sound of a fourth output channel based on the preprocessed sound of the fourth input channel; and an operation of generating a sound of a fifth output channel by combining the preprocessed sound of the first input channel, the preprocessed sound of the second input channel, the preprocessed sound of the third input channel, and the preprocessed sound of the fourth input channel and dividing the combined sound by a designated value.

In a method of operating an electronic device according to an embodiment, the operation of the first mode may include an operation of generating a sound of a first output channel by performing beamforming processing on the preprocessed sound of the first input channel in a first direction; an operation of generating a sound of a second output channel by performing beamforming processing on the preprocessed sound of the second input channel in the first direction; an operation of generating a sound of a third output channel by performing beamforming processing on the preprocessed sound of the third input channel in a second direction; an operation of generating a sound of a fourth output channel by performing beamforming processing on the preprocessed sound of the fourth input channel in the second direction; and an operation of generating a sound of a fifth output channel by combining the preprocessed sound of the first input channel, the preprocessed sound of the second input channel, the preprocessed sound of the third input channel, and the preprocessed sound of the fourth input channel and dividing the combined sound by a designated value.

A method of operating an electronic device according to an embodiment may include generating a sound of a first output channel by performing beamforming processing on the preprocessed sound of a first input channel in a first direction; generating a sound of a second output channel by performing beamforming processing on the preprocessed sound of a second input channel in a second direction; generating a sound of a third output channel by performing beamforming processing on the preprocessed sound of a third input channel in a third direction; generating a sound of a fourth output channel by performing beamforming processing on the preprocessed sound of a fourth input channel in a fourth direction; and generating a sound of a fifth output channel by combining the preprocessed sound of the first input channel, the preprocessed sound of the second input channel, the preprocessed sound of the third input channel, and the preprocessed sound of the fourth input channel and dividing the combined sound by a designated value.

In a method of operating an electronic device according to an embodiment, the operation of the second mode may include an operation of tracking a position of a target sound based on the preprocessed sound of the first input channel, the preprocessed sound of the second input channel, and a preprocessed sound of the third input channel, and the preprocessed sound of the fourth input channel, an operation of determining a designated direction to receive the sound based on the position of the target sound, and an operation of amplifying and receiving a target sound by performing beamforming processing on the preprocessed sound of the first input channel, the preprocessed sound of the second input channel, the preprocessed sound of the third input channel, and the preprocessed sound of the fourth input channel in a designated direction based on the position of the target sound.

A method of operating an electronic device according to an embodiment may further include outputting the amplified and received target sound to a speaker.

A method of operating an electronic device according to an embodiment may further include tracking a user's gaze using a camera and determining a designated direction to collect a sound based on the user's gaze tracked by the camera.

A method of operating an electronic device according to an embodiment may further include detecting a vibration using a sensor, and amplifying and receiving a target sound by performing beamforming processing on the preprocessed sound of the first input channel, the preprocessed sound of the second input channel, the preprocessed sound of the third input channel, and the preprocessed sound of the fourth input channel in a preconfigured designated direction corresponding to the sensor detecting a vibration of a designated pattern, in a third mode.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a first microphone disposed at a left front surface of the electronic device to collect a sound of a first input channel;
a second microphone disposed at a left rear surface of the electronic device to collect a sound of a second input channel;
a third microphone disposed at a right front surface of the electronic device to collect a sound of a third input channel;
a fourth microphone disposed at a right rear surface of the electronic device to collect a sound of a fourth input channel;
memory storing one or more computer programs; and
one or more processors communicatively coupled to the first microphone, the second microphone, the third microphone, the fourth microphone, and the memory,
wherein the one or more computer programs include computer-executable instructions that, when executed by the one or more processors individually or collectively, cause the electronic device to:
preprocess the sound of the first input channel, the sound of the second input channel, the sound of the third input channel, and the sound of the fourth input channel, and
operate in a first mode that records immersive audio based on the preprocessed sound of the first input channel, the preprocessed sound of the second input channel, the preprocessed sound of the third input channel, and the preprocessed sound of the fourth input channel, or
operate in a second mode that receives a sound of a designated direction using beamforming based on the preprocessed sound of the first input channel, the preprocessed sound of the second input channel, the preprocessed sound of the third input channel, and the preprocessed sound of the fourth input channel.

2. The electronic device of claim 1,
wherein the first microphone and the third microphone are disposed symmetrically about the electronic device while being spaced apart by a first distance,
wherein the second microphone and the fourth microphone are disposed symmetrically about the electronic device while being spaced apart by the first distance,
wherein the first microphone and the second microphone are disposed apart by a second distance, and
wherein the third microphone and the fourth microphone are disposed apart by the second distance.

3. The electronic device of claim 1, wherein in the first mode, the one or more computer programs further include computer-executable instructions that, when executed by the one or more processors individually or collectively, cause the electronic device to:
combine the preprocessed sound of the first input channel and the preprocessed sound of the second input channel and divide the combined sound by a designated value to generate a sound of a first output channel, and
combine the preprocessed sound of the third input channel and the preprocessed sound of the fourth input channel, and divide the combined sound by a designated value to generate a sound of a second output channel.

4. The electronic device of claim 1, wherein in the first mode, the one or more computer programs further include computer-executable instructions that, when executed by the one or more processors individually or collectively, cause the electronic device to:
generate a sound of a first output channel based on the preprocessed sound of the first input channel,
generate a sound of a second output channel based on the preprocessed sound of the second input channel,
generate a sound of a third output channel based on the preprocessed sound of the third input channel,
generate a sound of a fourth output channel based on the preprocessed sound of the fourth input channel, and
combine the preprocessed sound of the first input channel, the preprocessed sound of the second input channel, the preprocessed sound of the third input channel, and the preprocessed sound of the fourth input channel and divide the combined sound by a designated value to generate a sound of a fifth output channel.

5. The electronic device of claim 1, wherein in the first mode, the one or more computer programs further include computer-executable instructions that, when executed by the one or more processors individually or collectively, cause the electronic device to:
perform beamforming processing on the preprocessed sound of the first input channel in a first direction to generate a sound of a first output channel,
perform beamforming processing on the preprocessed sound of the second input channel in the first direction to generate a sound of a second output channel,
perform beamforming processing on the preprocessed sound of the third input channel in a second direction to generate a sound of a third output channel,
perform beamforming processing on the preprocessed sound of the fourth input channel in the second direction to generate a sound of a fourth output channel, and
combine the preprocessed sound of the first input channel, the preprocessed sound of the second input channel, the preprocessed sound of the third input channel, and the preprocessed sound of the fourth input channel and divide the combined sound by a designated value to generate a sound of a fifth output channel.

6. The electronic device of claim 1, wherein in the first mode, the one or more computer programs further include computer-executable instructions that, when executed by the one or more processors individually or collectively, cause the electronic device to:
perform beamforming processing on the preprocessed sound of the first input channel in a first direction to generate a sound of a first output channel,
perform beamforming processing on the preprocessed sound of the second input channel in a second direction to generate a sound of a second output channel,
perform beamforming processing on the preprocessed sound of the third input channel in a third direction to generate a sound of a third output channel,
perform beamforming processing on the preprocessed sound of the fourth input channel in a fourth direction to generate a sound of a fourth output channel, and
combine the preprocessed sound of the first input channel, the preprocessed sound of the second input channel, the preprocessed sound of the third input channel, and the preprocessed sound of the fourth input channel and divide the combined sound by a designated value to generate a sound of a fifth output channel.

7. The electronic device of claim 1, wherein in the second mode, the one or more computer programs further include computer-executable instructions that, when executed by the one or more processors individually or collectively, cause the electronic device to:
track a position of a target sound based on the preprocessed sound of the first input channel, the preprocessed sound of the second input channel, the preprocessed sound of the third input channel, and the preprocessed sound of the fourth input channel,
determine a designated direction to collect a sound based on the position of the target sound, and
perform beamforming processing on the preprocessed sound of the first input channel, the preprocessed sound of the second input channel, the preprocessed sound of the third input channel, and the preprocessed sound of the fourth input channel in a designated direction to amplify and receive the target sound based on the position of the target sound.

8. The electronic device of claim 7,
wherein the electronic device further comprises a speaker, and
wherein the one or more computer programs further include computer-executable instructions that, when executed by the one or more processors individually or collectively, cause the electronic device to output the amplified and received target sound to the speaker.

9. The electronic device of claim 7,
wherein the electronic device further comprises a camera configured to track a user's gaze, and
wherein the one or more computer programs further include computer-executable instructions that, when executed by the one or more processors individually or collectively, cause the electronic device to determine a designated direction to collect a sound based on the user's gaze tracked by the camera.

10. The electronic device of claim 1,
wherein the electronic device further comprises a sensor configured to detect a vibration, and
wherein the one or more computer programs further include computer-executable instructions that, when executed by the one or more processors individually or collectively, cause the electronic device to:
operate in a third mode that enhances and receives a user's voice based on the preprocessed sound of the first input channel, the preprocessed sound of the second input channel, the preprocessed sound of the third input channel, and the preprocessed sound of the fourth input channel, and
perform beamforming processing on the preprocessed sound of the first input channel, the preprocessed sound of the second input channel, the preprocessed sound of the third input channel, and the preprocessed sound of the fourth input channel in a preconfigured designated direction to amplify and receive a target sound corresponding to the sensor detecting a vibration of a designated pattern, in the third mode.

11. A method performed by an electronic device,
wherein the electronic device comprises a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, and a fourth microphone disposed at a right rear surface thereof to collect a sound of a fourth input channel, and
wherein the method comprises:
preprocessing, by the electronic device, the sound of the first input channel, the sound of the second input channel, the sound of the third input channel, and the sound of the fourth input channel; and
operating, by the electronic device, in a first mode that records immersive audio based on the preprocessed sound of the first input channel, the preprocessed sound of the second input channel, the preprocessed sound of the third input channel, and the preprocessed sound of the fourth input channel; or
operating, by the electronic device, in a second mode that receives a sound of a designated direction using beamforming based on the preprocessed sound of the first input channel, the preprocessed sound of the second input channel, the preprocessed sound of the third input channel, and the preprocessed sound of the fourth input channel.

12. The method of claim 11,
wherein the first microphone and the third microphone are disposed symmetrically about the electronic device while being spaced apart by a first distance,
wherein the second microphone and the fourth microphone are disposed symmetrically about the electronic device while being spaced apart by the first distance,
wherein the first microphone and the second microphone are disposed apart by a second distance, and
wherein the third microphone and the fourth microphone are disposed apart by the second distance.

13. The method of claim 11, wherein the operation of the first mode comprises:
an operation of generating a sound of a first output channel by combining the preprocessed sound of the first input channel and the preprocessed sound of the second input channel and dividing the combined sound by a designated value; and
an operation of generating a sound of a second output channel by combining the preprocessed sound of the third input channel and the preprocessed sound of the fourth input channel and dividing the combined sound by a designated value.

14. The method of claim 11, wherein the operation of the first mode comprises:
an operation of generating a sound of a first output channel based on the preprocessed sound of the first input channel;
an operation of generating a sound of a second output channel based on the preprocessed sound of the second input channel;
an operation of generating a sound of a third output channel based on the preprocessed sound of the third input channel;
an operation of generating a sound of a fourth output channel based on the preprocessed sound of the fourth input channel; and
an operation of generating a sound of a fifth output channel by combining the preprocessed sound of the first input channel, the preprocessed sound of the second input channel, the preprocessed sound of the third input channel, and the preprocessed sound of the fourth input channel and dividing the combined sound by a designated value.

15. The method of claim 11, wherein the operation of the first mode comprises:
an operation of generating a sound of a first output channel by performing beamforming processing on the preprocessed sound of the first input channel in a first direction;
an operation of generating a sound of a second output channel by performing beamforming processing on the preprocessed sound of the second input channel in the first direction;
an operation of generating a sound of a third output channel by performing beamforming processing on the preprocessed sound of the third input channel in a second direction;
an operation of generating a sound of a fourth output channel by performing beamforming processing on the preprocessed sound of the fourth input channel in the second direction; and
an operation of generating a sound of a fifth output channel by combining the preprocessed sound of the first input channel, the preprocessed sound of the second input channel, the preprocessed sound of the third input channel, and the preprocessed sound of the fourth input channel and dividing the combined sound by a designated value.

16. The method of claim 15, wherein the operation of generating the sound of the first output channel comprises amplifying or equalizing (EQ) the sound of the first input channel corresponding to the first microphone to generate the sound of the first output channel.

17. The method of claim 11,
wherein the electronic device includes a hole of a microphone formed to face downward, and
wherein outside of the hole of the microphone is implemented in a dish-shaped antenna to collect a user's voice.

18. The method of claim 11, further comprising:
collecting the sound of the designated direction using the beamforming based on the preprocessed sound corresponding to sound detection.

19. One or more non-transitory computer-readable storage media storing one or more computer programs including computer-executable instructions that, when executed by one or more processors of an electronic device individually or collectively, cause the electronic device to perform operations,
wherein the electronic device comprises a first microphone disposed at a left front surface thereof to collect a sound of a first input channel, a second microphone disposed at a left rear surface thereof to collect a sound of a second input channel, a third microphone disposed at a right front surface thereof to collect a sound of a third input channel, and a fourth microphone disposed at a right rear surface thereof to collect a sound of a fourth input channel, and
wherein the operations comprise:
preprocessing, by the electronic device, the sound of the first input channel, the sound of the second input channel, the sound of the third input channel, and the sound of the fourth input channel, and
operating, by the electronic device, in a first mode that records immersive audio based on the preprocessed sound of the first input channel, the preprocessed sound of the second input channel, the preprocessed sound of the third input channel, and the preprocessed sound of the fourth input channel, or
operating, by the electronic device, in a second mode that receives a sound of a designated direction using beamforming based on the preprocessed sound of the first input channel, the preprocessed sound of the second input channel, the preprocessed sound of the third input channel, and the preprocessed sound of the fourth input channel.

20. The one or more non-transitory computer-readable storage media of claim 19,
wherein the first microphone and the third microphone are disposed symmetrically about the electronic device while being spaced apart by a first distance,
wherein the second microphone and the fourth microphone are disposed symmetrically about the electronic device while being spaced apart by the first distance,
wherein the first microphone and the second microphone are disposed apart by a second distance, and
wherein the third microphone and the fourth microphone are disposed apart by the second distance.
